(19) United States
(12) Patent Application Publication
(10) Pub. No.: US 2006/0037062 A1
(43) Pub. Date: Feb. 16, 2006

(54) Method, system and program product for securing resources in a distributed system

(75) Inventors: Carlos Cesar F. Araujo, Cary, NC (US); John E. Dinger, Cary, NC (US); Denilson Nastacio, Apex, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/914,689

(22) Filed: Aug. 9, 2004

(51) Int. Cl. H04L 9/32

(52) U.S. Cl. 726/2

(57) ABSTRACT

Under the present invention, a mapping is provided that interrelates security permissions for an application-based resource with security permissions for a set of IT-based resources in the distributed system. When a desired security permission for the application-based resource is expressed, the mapping can be accessed to determine the corresponding security permissions for the IT-based resources. Once these security permissions are determined, resource plug-ins corresponding to the IT-based resources will effect their respective security permissions.

### BACKGROUND OF THE INVENTION

1. Field of the Invention

In general, the present invention relates to a method, system and program product for securing applications in a distributed system/environment. Specifically, the present invention allows security permissions for separate resources to be interrelated for improved security management.

2. Related Art

As the use of distributed systems such as computer networks becomes more pervasive, there is a growing need to provide improved security for the resources therein. Specifically, distributed systems often require some mechanism to protect resources across the network. One popular approach is the association of access control lists (ACLs) with a resource, and the authorization of user credentials to authorize access to the resource. One problem with such an approach is that the traditional nature of resources does not relate to applications built around the resources. For example, although IT-based resources such as a database table and a messaging destination or topic have their own authentication/authorization mechanisms, these resources have no way to understand how they integrate into a larger solution that utilizes both a database engine and a messaging system. Thus, if an application stores a token of data and then publishes a notification about the same token of data, it is the token of data that is seen as a resource by the application as opposed to the messaging system and database engine. On the other hand, the application cannot secure the resource by itself because it will need the database engine and the messaging system to enforce access to the database tables and messages.

One existing approach is for the application and the IT components to define ACL management infrastructures of their own. Unfortunately, with such an approach, any changes to security permissions for resources that are interrelated typically will be propagated to the resources through separate, deliberate actions. Thus, if a change to a security permission for an application-based resource requires corresponding changes to security permissions for interrelated IT-based resources, a system administrator or the like will have to access each system separately to make the changes.

In view of the foregoing, there exists a need for a method, system and program product for securing resources in a distributed system. Specifically, a need exists whereby security permissions for an application-based resource can be interrelated with or mapped to security permissions for IT-based resources used by the application. A further need exists for the mapping to be used to effect corresponding security permissions for the IT-based resources when a desired security permission for the application-based resource is expressed.

### SUMMARY OF THE INVENTION

In general, the present invention provides a method, system and program product for securing resources in a distributed system. Specifically, under the present invention, a mapping is provided that interrelates security permissions for an application-based resource with security permissions for a set of IT-based resources in the distributed system. When a desired security permission for the application-based resource is expressed, the mapping can be accessed to determine the corresponding security permissions for the IT-based resources. Once these security permissions are determined, resource plug-ins corresponding to the IT-based resources will effect their respective security permissions.

A first aspect of the present invention provides a method for securing resources in a distributed system, comprising: providing a security permission mapping that interrelates security permissions for an application-based resource with security permissions for a set of IT-based resources in the distributed system; receiving a desired security permission for the application-based resource; determining specific security permissions for the set of IT-based resources that correspond to the desired security permission based on the security permission mapping; and effecting the specific security permissions for the set of IT-based resources.

A second aspect of the present invention provides a system for securing resources in a distributed system, comprising: a security permission mapping for interrelating security permissions for an application-based resource with security permissions for a set of IT-based resources in the distributed system; and a set of resource plug-ins corresponding to the set of IT-based resources, wherein the security permission mapping is accessed to determine specific security permissions for the set of IT-based resources that correspond to a desired security permission for the application-based resource, and wherein the set of resource plug-ins effect the specific security permissions for the set of IT-based resources.

A third aspect of the present invention provides a system for securing resources in a distributed system, comprising: means for accessing a security permission mapping that interrelates security permissions for an application-based resource with security permissions for a set of IT-based resources in the distributed system; means for determining specific security permissions for the set of IT-based resources that correspond to a desired security permission for the application-based resource based on the security permission mapping; and means for effecting the specific security permissions for the set of IT-based resources.

A fourth aspect of the present invention provides a program product stored on a recordable medium for securing resources in a distributed system, which when executed, comprises: program code for accessing a security permission mapping that interrelates security permissions for an application-based resource with security permissions for a set of IT-based resources in the distributed system; program code for determining specific security permissions for the set of IT-based resources that correspond to a desired security permission for the application-based resource based on the security permission mapping; and program code for effecting the specific security permissions for the set of IT-based resources.

A fifth aspect of the present invention provides a system for deploying an application for securing resources in a distributed system, comprising: a computer infrastructure being operable to: access a security permission mapping that interrelates security permissions for an application-based resource with security permissions for a set of IT-based resources in the distributed system; determine specific security permissions for the set of IT-based resources that correspond to a desired security permission for the application-based resource based on the security permission mapping; and effect the specific security permissions for the set of IT-based resources.

A sixth aspect of the present invention provides computer software embodied in a propagated signal for securing resources in a distributed system, the computer software comprising instructions to cause a computer system to perform the following functions: access a security permission mapping that interrelates security permissions for an application-based resource with security permissions for a set of IT-based resources in the distributed system; determine specific security permissions for the set of IT-based resources that correspond to a desired security permission for the application-based resource based on the security permission mapping; and effect the specific security permissions for the set of IT-based resources.

Therefore, the present invention provides a method, system and program product for securing resources in a distributed system.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for securing resources in a distributed system according to the present invention.

FIG. 2 depicts a computerized implementation of the system of FIG. 1.

FIG. 3 depicts a method flow diagram according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

For convenience purposes, the Detailed Description of the Drawings will have the following sections:

I. General Description

II. Computerized Implementation

I. General Description

As indicated above, the present invention provides a method, system and program product for securing resources in a distributed system. Specifically, under the present invention, a mapping is provided that interrelates security permissions for an application-based resource with security permissions for a set of IT-based resources in the distributed system. When a desired security permission for the application-based resource is expressed, the mapping can be accessed to determine the corresponding security permissions for the IT-based resources. Once these security permissions are determined, resource plug-ins corresponding to the IT-based resources will effect their respective security permissions.

It should be understood in advance that as used herein, the term “IT-based resource” is intended to refer to any type of information technology resource used within a distributed system. Examples of IT-based resources include messaging destinations or topics maintained by a messaging infrastructure, database tables maintained by a database engine, sockets, etc. Further, the term “application-based resource” is intended to refer to a resource used by a specific application operable within the distributed system. Examples of application-based resources include payroll data (e.g., where the application is a payroll application), insurance claims (e.g., where the application is an insurance claim processing application), business orders (e.g., where the application is a procurement application), etc. Moreover, the term “security permission” is intended to refer to any type of action that can be performed with respect to a resource. Examples of “security permissions” include querying, subscribing, reading, writing, etc. Still yet, the term “set” is intended to refer to one or more items/objects. For example, a “set” of IT-based resources means one or more IT-based resources.

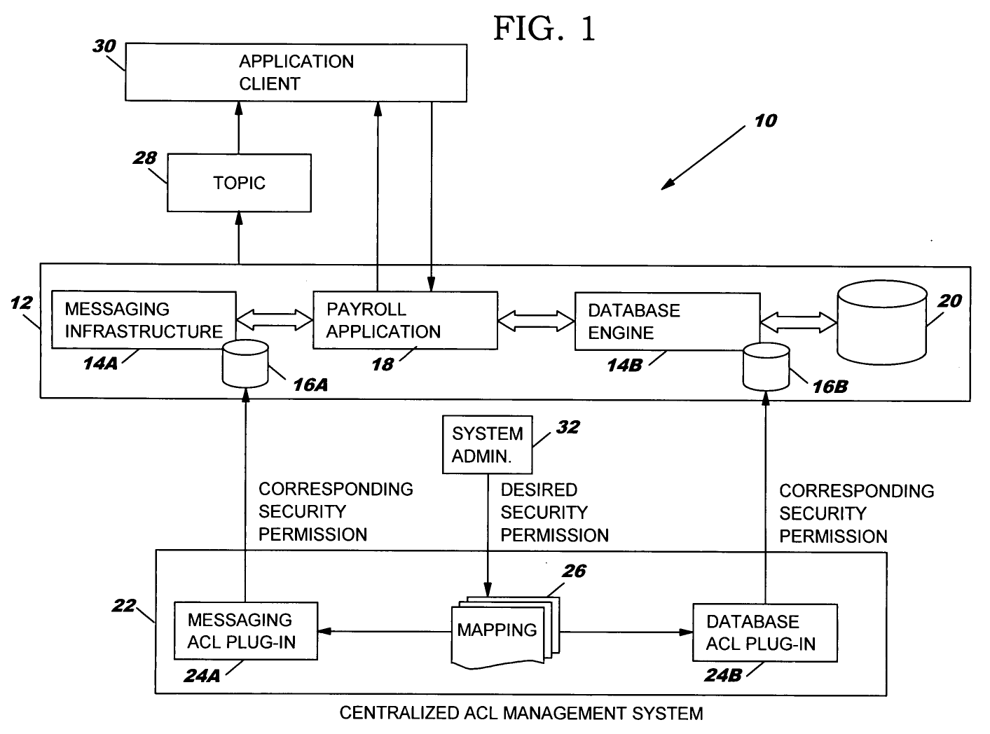

Referring now to FIG. 1 a system 10 for securing resources in a distributed system 12 is shown. Under the present invention, a centralized ACL management system 22 is provided that allows for consolidation/centralization of security management among disparate resources. Specifically, centralized ACL management system 22 allows security permissions for application-based resources to be associated with security permissions for interrelated IT-based resources. As an illustrative example, FIG. 1 depicts a payroll application 18 that works in conjunction with “middleware” IT components, namely, messaging infrastructure 14A and database engine 14B (which itself accesses database 20). As further shown, messaging infrastructure 14A and database engine 14B each include their own ACL repository 16A-B, respectively. Under this illustrative embodiment, and under the definitions set forth above, resources used by messaging infrastructure 14A (e.g., messaging destinations, topics, etc.) and database engine 14B (e.g., database 20 tables, etc.) would be considered to be IT-based resources. Conversely, resources used by payroll application 18 (e.g., payroll data, etc.) would be considered to be application-based resources. It should be clearly understood that the depiction of messaging infrastructure 14A, database engine 14B and payroll application 18 is intended to be illustrative only, and that the teachings of the present invention can be applied to any type of applications, middleware components and/or resources.

In any event, application client 30 is shown accessing payroll application 18. In order to fully exploit payroll application 18, interactions with messaging infrastructure 14A and database engine 14B might be needed. That is, in order to fully exploit payroll application 18, application client 30 might subscribe to one or more messaging topics 28 via messaging infrastructure 14A (e.g., to receive payroll-related notifications), and access data contained in one or more tables of database 20. In most instances, such as the illustrative embodiment shown in FIG. 1, components such as messaging infrastructure 14A and database engine 14B can have their own ACL repositories 16A-B containing their respective security permissions. Each ACL entry is typically a “tuple” comprised of a user (or group of users), a security permission, and a resource. For example, an ACL entry in database engine ACL repository 166B could state “User A, read-only, table XYZ.” This indicates that User A can only read data in table XYZ (as opposed to being able to read or write to table XYZ). Under previous systems, effecting a security permission change in database engine ACL repository 16B (e.g., adding a security permission for a user) required a system administrator 32 or the like to access database engine ACL repository 16B and implement the change.

Unfortunately, such a requirement can be unduly burdensome when security permissions for various resources are interrelated. For example, adding a particular security permission for an application-based resource might require adding other security permissions for certain IT-based resources of the components (e.g., messaging infrastructure 14A and database engine 14B) that are used in conjunction with the application. Due to the disparate security management currently provided (e.g., separate ACL repositories), to date this has required a separate, deliberate operation for each security permission sought to be added.

To address this, the present invention provides a centralized ACL management system 22, which is shown including a security permission mapping 26 (hereinafter mapping 26) and resource plug-ins 24A-B. Resource plug-ins 24A-B typically correspond to the components with which application 18 works in conjunction. To this extent, under the illustrative embodiment of FIG. 1, a messaging ACL plug-in 24A and a database ACL plug-in 24B are provided. Resource plug-ins 24A-B are typically provided by the developers of components 14A-B, respectively.

Under the present invention, mapping 26 associates the security permissions for application-based resources with security permissions for interrelated/interdependent IT-based resources. Mapping the security permissions in this manner creates a linkage/association between the security permissions for the various interrelated resources in distributed system 12. Shown below is illustrative logic in Extensible Markup Language (XML) depicting the mapping of a security permission for an application-based resource to security permissions for related IT-based resources:

<resource_manager>

<application name=“payroll”/>
<resource name=“employee data”/>

</resource_manager>
<resource_manager>

<application name=“messaging provider”/>
<resource name=“topic abc”/>

</resource_manager>
<resource_manager>

<application name=“database engine”/>
<resource name=“table xyz”/>

</resource_manager>
<resource_relationship>

<master_resource

name=“myApp”
resource_name=“employee data”
permission=“query”/>

<subordinate_resource

name=“messaging provider”
resource_name=“topic abc”
permission=“subscribe”/>

<subordinate_resource

name=“database engine”
resource name=“table xyz”
permission=“read, write”/>

<resource_relationship>

The <resource_manager> portions of the above logic set forth the three resources that are interrelated in this illustrative embodiment, namely, “employee data” (application-based resource), messaging “topic ABC” (IT-based resource) and database “table XYZ” (IT-based resources). The <resource_relationship> portion of the logic sets forth the security permission linkages/associations for those resources. Specifically, the <resource_relationship> logic indicates that a security permission change for the application-based resource “employee data” has to be propagated to the IT-based resource “topic ABC” in messaging infrastructure 14A and to the IT-based resource “table XYZ” in database engine 14B. More specifically, according to the above illustrative logic, adding the “query” security permission for “employee data” should result in adding the “subscribe” security permission for “topic ABC” and the “read, write” security permission for “table XYZ.”

Under the present invention, when a system administrator 32 or the like provides a desired security permission (e.g., adds, edits or deletes a security permission) for an application-based resource, centralized ACL management system 22 will access mapping 26 to determine the specific security permissions for the IT-based resources that correspond thereto. Specifically, if the security permission input for the application-based resource is interrelated with the security permission(s) of any IT-based resources, the security permissions for the IT-based resources will be retrieved from mapping 26. For example, using the above logic, if system administrator 32 desired to add the “query” security permission for User A for “employee data,” it will be determined that the “subscribe” security permission should also be added for User A for “topic ABC,” while the “read, write” security permission should be added for User A for “table XYZ.” Once these corresponding permissions for the IT-based resources have been determined, resource plug-ins 24A-B will effect the same for their respective resources. Specifically, messaging ACL plug-in 24A will write the “subscribe” security permission for User A for “topic ABC” to ACL repository 16A, while database ACL plug-in 24B will write the “read, write” security permission for User A for “table XYZ” to ACL repository 16B.

It should be understood that the examination of mapping 26 to determine the corresponding security permissions for the IT-based resources could be performed by resource plug-ins 24A-B, or by a separate system (not shown in FIG. 1). Moreover, it should be understood that system administrator 32 will typically be provided with a graphical user interface or the like (e.g., a command line interface) for providing the desired security permission. Such an interface could also provide system administrator 32 with a view of all resources and/or resource managers registered with centralized ACL management system 22. In any event, by providing the centralized ACL management system 22 of the present invention, a system administrator 22 need only designate an end result, such as a desired security permission for an application-based resource. Once designated, system administrator 32 need not be concerned with the propagation of corresponding security permissions for interrelated IT-based resources. It should also be understood that the present invention is not limited to the adding of permissions as discussed in conjunction with the illustrative example set forth above. Rather the same teachings could be also used to accommodate the propagation of any change or deletion of security permissions. For example, mapping 26 could contain an entry indicating that the deletion of the “query” security permission for “employee data” should be accompanied by the deletion of the “subscribe” permission for “topic ABC” and the “read, write” security permission for “table XYZ.” To this extent, the “providing of a desired security permission” under the present invention can be a request to add a new security permission, or to edit or delete an existing security permission.

II. Computerized Implementation

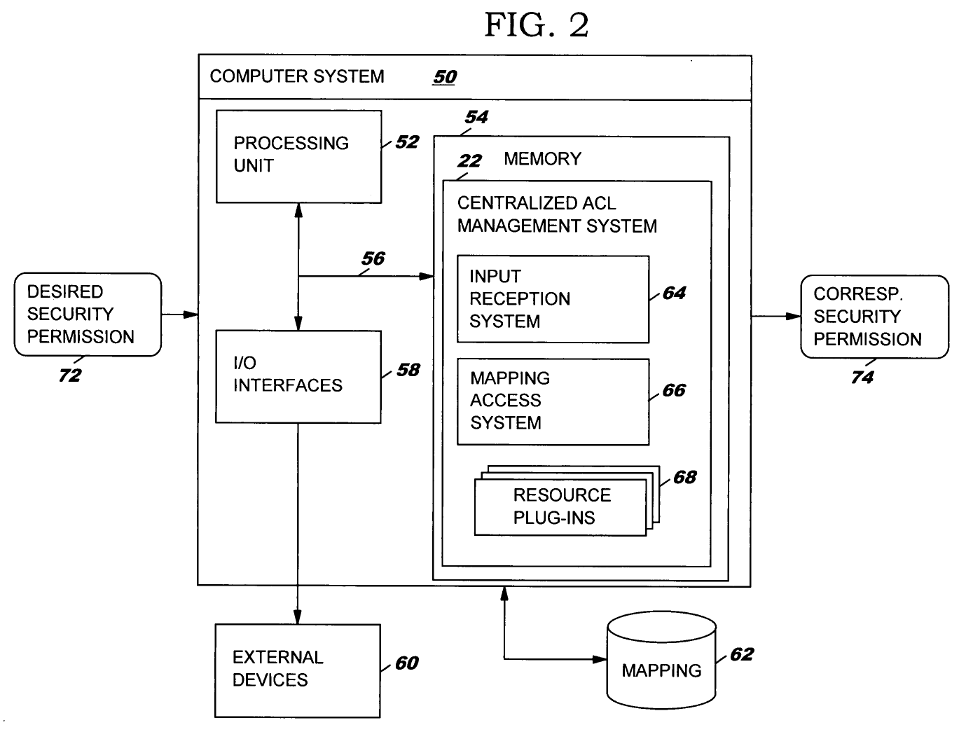

In a typical embodiment, the present invention is realized in a computerized environment. Referring to FIG. 2, a more detailed diagram of a computerized implementation of the present invention is shown. As depicted, the centralized ACL management system 22 is realized on computer system 50 as one or more program products. Computer system 50 is intended to represent any type of computerized system capable of carrying out the teachings of the present invention. For example, computer system 50 could be a desktop computer, laptop computer, a workstation, a handheld device, a server, etc.

In general, communication with computer system 50 occurs in a distributed environment such as over a network. Examples of a network include the Internet, a local area network (LAN), a wide area network (WAN), a virtual private network (VPN), etc. In any event, a direct hardwired connection (e.g., serial port), or an addressable connection could be implemented. The addressable connection may utilize any combination of wireline and/or wireless transmission methods. Moreover, conventional network connectivity, such as Token Ring, Ethernet, WiFi or other conventional communications standards could be used. Still yet, connectivity could be provided by conventional IP-based protocol.

As also depicted, computer system 50 generally comprises processing unit 52, memory 54, bus 56, input/output (I/O) interfaces 58, external devices/resources 60 and storage unit 62. Processing unit 52 may comprise a single processing unit, or be distributed across one or more processing units in one or more locations, e.g., on a client and server. Memory 54 may comprise any known type of data storage and/or transmission media, including magnetic media, optical media, random access memory (RAM), read-only memory (ROM), a data cache, a data object, etc. Moreover, similar to processing unit 52, memory 54 may reside at a single physical location, comprising one or more types of data storage, or be distributed across a plurality of physical systems in various forms.

I/O interfaces 58 may comprise any system for exchanging information to/from an external source. External devices/resources 60 may comprise any known type of external device, including speakers, a CRT, LED screen, hand-held device, keyboard, mouse, voice recognition system, speech output system, printer, monitor/display, facsimile, pager, etc. Bus 56 provides a communication link between each of the components in computer system 50 and likewise may comprise any known type of transmission link, including electrical, optical, wireless, etc.

Storage unit 62 can be any system (e.g., a database, etc.) capable of providing storage for information under the present invention. Such information could include, among other things, a security permission mapping 26. As such, storage unit 62 could include one or more storage devices, such as a magnetic disk drive or an optical disk drive. In another embodiment, storage unit 62 includes data distributed across, for example, a local area network (LAN), wide area network (WAN) or a storage area network (SAN) (not shown).

Although not shown, additional components, such as cache memory, communication systems, system software, etc., may be incorporated into computer system 50. Moreover, it should be understood that any computer system(s) (e.g., clients) communicating with computer system 50 will likely include computerized components similar to computer system 50.

Shown in memory 54 of computer system 50 is centralized ACL management system 22. Under the embodiment shown in FIG. 2, centralized ACL management system 22 includes an input reception system 64, a mapping access system 66 and resource plug-ins 68. Input reception system 64 can provide a system administrator or the like with any interfaces (graphical user interface, command line interface, etc.) for providing a desired security permission 72, as well as a view of the resources and/or resource managers on the distributed system. In any event, when desired security permission 72 is received by input reception system 64, mapping access system 66 will access the security permission mapping 26 (e.g., as stored in storage unit 62). Based on the desired security permission 72, mapping access system 66 will determine any corresponding interrelated security permissions. For example, if desired security permission 72 was for an application-based resource, mapping access system 66 will examine/analyze the mapping to determine the specific security permissions 74 for any IT-based resources interrelated with the application-based resource. Once such security permissions 74 have been determined, resource plug-ins 68 will effect the same for their respective resources. Thus, if security permissions 74 were for IT-based resources A and B, security permissions 74 will be effected by the respective resource plug-ins 68. As indicated above, this could include writing the security permissions to their respective ACL repositories.

It should be appreciated that although not shown, a mapping configuration system could also be provided within centralized ACL management system 22. Such a system would allow a system administrator or the like to create, update and/or upload the security permission mapping.

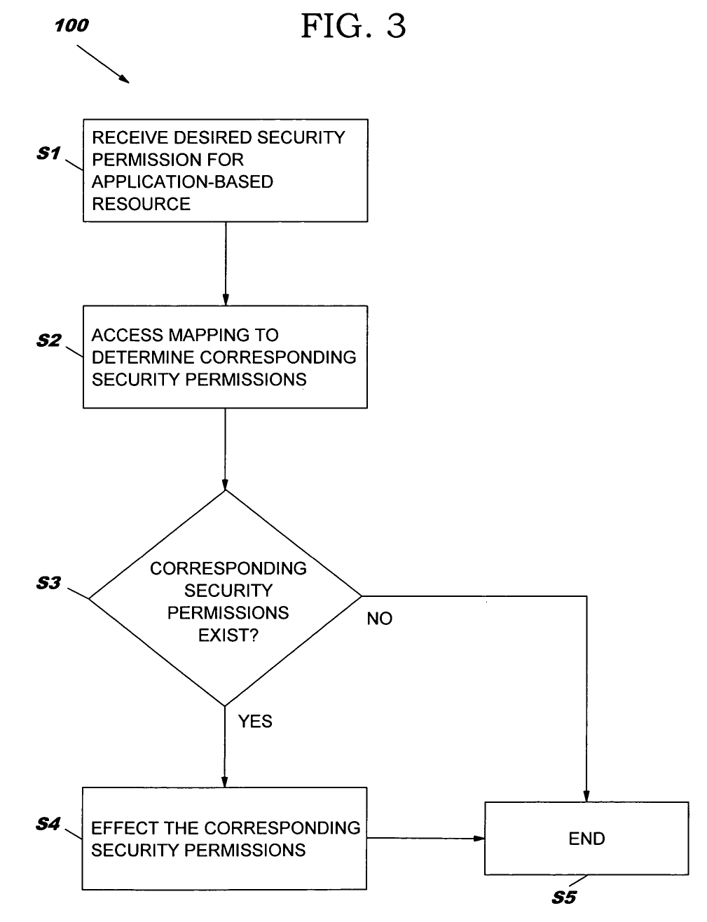

Referring now to FIG. 3 a method flow diagram 100 according to the present invention is shown. As depicted, first step S1 is to receive a desired security permission for an application-based resource. Second step S2 is to access a mapping to determine corresponding security permissions for IT-based resources interrelated with the application-based resource. If corresponding security permissions are not found in Step S3, the process can be terminated in step S5. If, however, corresponding security permissions are found, they will be effected in step S4 before the process is terminated in step S5.

It should be appreciated that the teachings of the present invention could be offered as a business method on a subscription or fee basis. For example, centralized ACL management system 22 (FIG. 1), and/or computer system 50 (FIG. 2) could be created, maintained, supported and/or deployed by a service provider that offers the functions described herein for customers. That is, a service provider could offer to manage security permissions for interrelated resources as described above.

It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, the centralized ACL management system 22 of FIGS. 1 and 2 is intended to be illustrative only.

We claim:

1. A method for securing resources in a distributed system, comprising:
providing a security permission mapping that interrelates security permissions for an application-based resource with security permissions for a set of IT-based resources in the distributed system;
receiving a desired security permission for the application-based resource;
determining specific security permissions for the set of IT-based resources that correspond to the desired security permission based on the security permission mapping; and
effecting the specific security permissions for the set of IT-based resources.

2. The method of claim 1, wherein the security permission mapping contains an association of the desired security permission with the specific security permissions.

3. The method of claim 1, wherein the desired security permission and the specific security permissions pertain to a specific user or group of users.

4. The method of claim 1, wherein the effecting step comprises writing the specific security permissions to respective Access Control List (ACL) repositories for the set of IT-based resources.

5. The method of claim 1, wherein an application associated with the application-based resource is interrelated with a set of components associated with the set of IT-based resources.

6. The method of claim 1, wherein the effecting step is performed by a set of resource plug-ins that corresponds to the set of IT-based resources.

7. The method of claim 1, wherein the security permission mapping is provided in Extensible Markup Language (XML).

8. A system for securing resources in a distributed system, comprising:
a security permission mapping for interrelating security permissions for an application-based resource with security permissions for a set of IT-based resources in the distributed system; and
a set of resource plug-ins corresponding to the set of IT-based resources, wherein the security permission mapping is accessed to determine specific security permissions for the set of IT-based resources that correspond to a desired security permission for the application-based resource, and wherein the set of resource plug-ins effect the specific security permissions for the set of IT-based resources.

9. The system of claim 8, wherein the security permission mapping contains an association of the desired security permission with the specific security permissions.

10. The system of claim 8, wherein the desired security permission and the specific security permissions pertain to a specific user or group of users.

11. The system of claim 8, wherein the set of resource plug-ins write the specific security permissions to respective Access Control List (ACL) databases for the set of IT-based resources.

12. The system of claim 8, wherein implementation of the desired security permission results in implementation of the specific security permissions.

13. The system of claim 8, wherein the security permission mapping is provided in Extensible Markup Language (XML).

14. The system of claim 8, further comprising a mapping access system for accessing the security permission mapping and for determining the specific security permissions based on the desired security permission.

15. A system for securing resources in a distributed system, comprising:
means for accessing a security permission mapping that interrelates security permissions for an application-based resource with security permissions for a set of IT-based resources in the distributed system;
means for determining specific security permissions for the set of IT-based resources that correspond to a desired security permission for the application-based resource based on the security permission mapping; and
means for effecting the specific security permissions for the set of IT-based resources.

16. A program product stored on a recordable medium for securing resources in a distributed system, which when executed, comprises:
program code for accessing a security permission mapping that interrelates security permissions for an application-based resource with security permissions for a set of IT-based resources in the distributed system;
program code for determining specific security permissions for the set of IT-based resources that correspond to a desired security permission for the application-based resource based on the security permission mapping; and
program code for effecting the specific security permissions for the set of IT-based resources.

17. The program product of claim 16, wherein the security permission mapping contains an association of the desired security permission with the specific security permissions.

18. The program product of claim 16, wherein the desired security permission and the specific security permissions pertain to a specific user or group of users.

19. The program product of claim 16, wherein the program code for effecting writes the specific security permissions to respective Access Control List (ACL) databases for the set of IT-based resources.

20. The program product of claim 16, wherein implementation of the desired security permission results in implementation of the specific security permissions.

21. The program product of claim 16, wherein the security permission mapping is provided in Extensible Markup Language (XML).

22. A system for deploying an application for securing resources in a distributed system, comprising:
a computer infrastructure being operable to:
access a security permission mapping that interrelates security permissions for an application-based resource with security permissions for a set of IT-based resources in the distributed system;
determine specific security permissions for the set of IT-based resources that correspond to a desired security permission for the application-based resource based on the security permission mapping; and
effect the specific security permissions for the set of IT-based resources.

23. Computer software embodied in a propagated signal for securing resources in a distributed system, the computer software comprising instructions to cause a computer system to perform the following functions:
access a security permission mapping that interrelates security permissions for an application-based resource with security permissions for a set of IT-based resources in the distributed system;
determine specific security permissions for the set of IT-based resources that correspond to a desired security permission for the application-based resource based on the security permission mapping; and
effect the specific security permissions for the set of IT-based resources.
